(19) United States
(12) Patent Application Publication
(10) Pub. No.: US 2021/0226378 A1
(43) Pub. Date: Jul. 22, 2021

(54) CONNECTOR

(71) Applicant: YAZAKI CORPORATION, Tokyo (JP)

(72) Inventors: Akira Sato, Makinohara-shi (JP); Hisaya Shibata, Makinohara-shi (JP)

(21) Appl. No.: 17/151,074

(22) Filed: Jan. 15, 2021

(30) Foreign Application Priority Data
Jan. 17, 2020 (JP) 2020-006206

(51) Int. Cl. H01R 13/52; H01R 13/04

(52) U.S. Cl. CPC H01R 13/521; H01R 13/04; H01R 43/18; H01R 2201/26; H01R 13/5202

(57) ABSTRACT

A connector includes: a housing of a resin material; a buffer member of a material having a higher flexibility than the resin material of the housing and being embedded in the housing; and a metal conductor having a bent portion and being held in the housing so as for the bent portion being covered by the buffer member.

### CROSS-REFERENCE TO RELATED APPLICATIONS

This application is based on and claims priority under 35 USC 119 from Japanese Patent Application No. 2020-006206 filed on Jan. 17, 2020, the contents of which are incorporated herein by reference.

### TECHNICAL FIELD

The present invention relates to a connector in which a metal conductor is held in a housing formed of a resin material.

### BACKGROUND ART

The related art proposed a connector in which a terminal fitting is insert-molded in a housing formed of a resin material. For example, in the connector in the related art, after the terminal fitting is insert-molded in a manner of passing through a partition wall that partitions a pair of fitting spaces for receiving a counterpart connector, a sealing material in a liquid form is injected and cured so as to close a gap between the terminal fitting and the housing. The cured sealing material acts as a water stopping member that prevents water from entering from one fitting space to the other fitting space.

As for details of the above connector, refer to JP 2013-157256 A.

In a case where the connector is exposed to a temperature change when the connector is actually used, an internal stress may occur inside each of the housing and the terminal fitting around a boundary surface between the housing and the terminal fitting due to a difference in thermal deformation degrees of the housing and the terminal fitting. In particular, a large internal stress tends to occur (so-called stress concentration occurs) at a portion where the boundary surface between the housing and the terminal fitting is bent with a small radius of curvature.

When the terminal fitting insert-molded in the housing has a bent portion, the boundary surface between the housing and the terminal fitting also has a bent portion. When excessively large stress concentration occurs in such a bent portion, deformation, cracking, or the like may occur in the housing starting from the bent portion. Since such deformation or cracking may cause a reduction in strength of the housing, it is preferable that there is no such deformation or cracking. For example, in a connector used in an environment in which water stopping is required, when strength of the housing is reduced, there is a possibility that a water stopping property cannot be exhibited as designed. Thus, it is desirable that the strength of the housing is maintained as much as possible even when the connector is exposed to a temperature change from the viewpoint of properly exhibiting an original function.

### SUMMARY OF INVENTION

Aspects of non-limiting embodiments of the present disclosure relate to providing a connector having excellent resistance to a temperature change.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a connector comprising:

a housing comprising a resin material;

a buffer member comprising a material having a higher flexibility than the resin material of the housing and being embedded in the housing; and

a metal conductor having a bent portion and being held in the housing so as for the bent portion being covered by the buffer member.

### BRIEF DESCRIPTION OF DRAWINGS

Exemplary embodiment(s) of the present invention will be described in detail based on the following figures, wherein:

FIG. 1 is a perspective view showing a connector according to an embodiment of the present invention as viewed from a front side;

FIG. 2 is a perspective view showing the connector shown in FIG. 1 as viewed from a rear side;

FIG. 3 is a side view showing a state in which the connector shown in FIG. 1 is attached to an outer wall of a case of a drive system component for a vehicle;

FIG. 4 is a perspective view showing a state in which intermediate portions of a plurality of metal terminals provided in the connector shown in FIG. 1 are collectively covered by a buffer member;

FIG. 5 is a cross-sectional view taken along a line A-A in FIG. 3; and

FIG. 6 is a conceptual diagram showing a bending angle of a metal terminal shown in FIG. 5.

### DESCRIPTION OF EMBODIMENTS

Hereinafter, a connector 1 according to an embodiment of the present invention will be described with reference to the drawings.

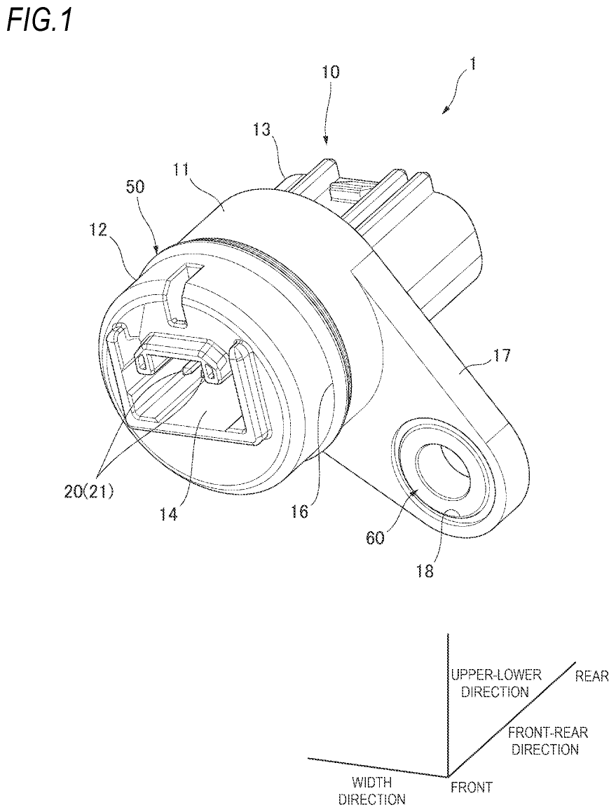

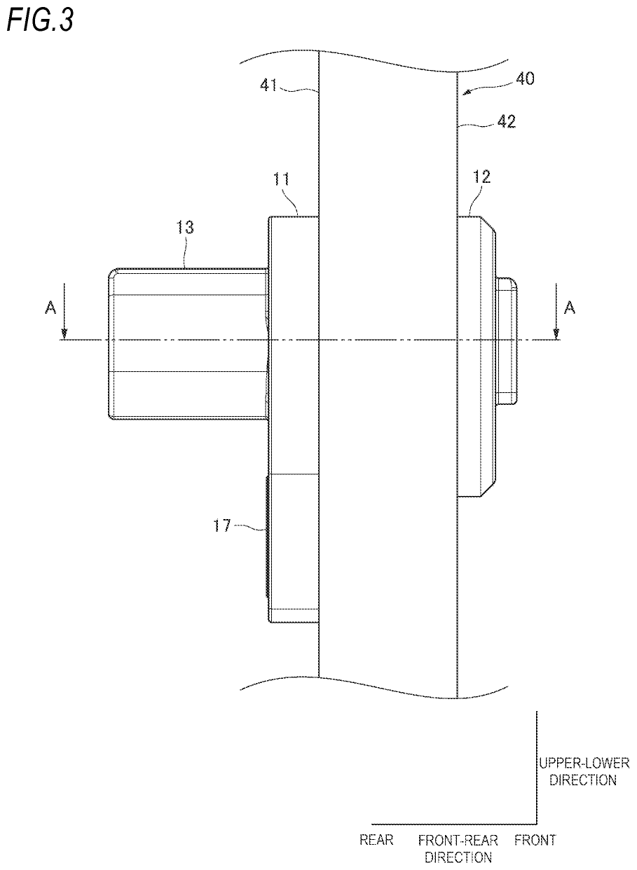

Typically, the connector 1 shown in FIG. 1 is attached to an outer wall 40 of a case of a drive system component for a vehicle as shown in FIG. 3. The connector 1 is used in a state in which a front connector portion 12 is exposed to oil (such as hydraulic oil) in the case and a rear connector portion 13 is exposed to air or water. Similarly, an outer surface 41 of the outer wall 40 is exposed to air or water outside the case, and an inner surface 42 of the outer wall 40 is exposed to oil stored in the case. The connector 1 functions as a relay connector that electrically connects a counterpart front connector (not shown) fitted to the front connector portion 12 and a counterpart rear connector (not shown) fitted to the rear connector portion 13.

Hereinafter, a “front-rear direction”, a “width direction”, an “upper-lower direction”, “front”, and “rear” as shown in FIG. 1 will be defined for the convenience of description. The “front-rear direction”, the “width direction”, and the “upper-lower direction” are orthogonal to one another. The front-rear direction coincides with a fitting direction of the front connector portion 12 and the counterpart front connector and a fitting direction of the rear connector portion 13 and the counterpart rear connector.

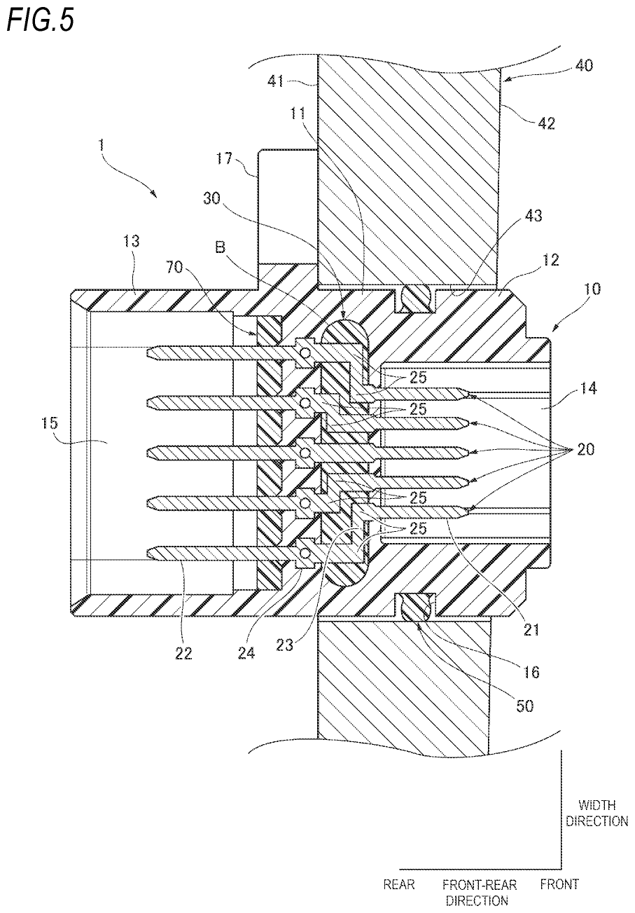

As shown in FIGS. 1 to 6, the connector 1 includes a housing 10, a plurality of metal terminals 20 held in the housing 10, and a buffer member 30 embedded in the housing 10 in a state of collectively covering intermediate portions 23 (see FIG. 5) of the plurality of metal terminals 20.

First, the housing 10 will be described. The housing 10 is a resin molded product. As shown in FIGS. 1 to 3 and FIG. 5, the housing 10 integrally includes a body portion 11, the front connector portion 12 located at a front side of the body portion 11, and the rear connector portion 13 located at a rear side of the body portion 11.

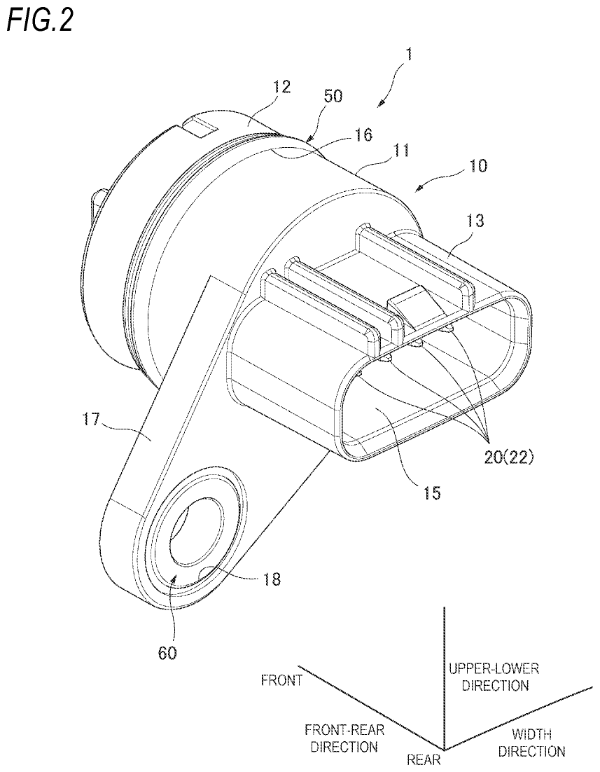

As shown in FIGS. 1 and 2, the body portion 11 has a cylindrical shape whose axis extends in the front-rear direction. As shown in FIG. 5, the intermediate portions 23 (to be described later) of the plurality of metal terminals 20 and the buffer member 30 that collectively covers a plurality of intermediate portions 23 are embedded in the body portion 11 by insert-molding.

As shown in FIGS. 1 and 2, the front connector portion 12 has a shape having an outer peripheral cylindrical surface extending coaxially from an outer peripheral cylindrical surface of the body portion 11 and extending continuously to the front side. As shown in FIGS. 1 and 5, a fitting recessed portion 14 recessed rearward is formed on a front end surface of the front connector portion 12. A bottom surface of the fitting recessed portion 14 is formed by a part of a front end surface of the body portion 11. The counterpart front connector is fitted to the fitting recessed portion 14.

As shown in FIGS. 1 and 2, the rear connector portion 13 has a rectangular tubular shape protruding rearward from a rear end surface of the body portion 11. As shown in FIGS. 2 and 5, a fitting recessed portion 15 recessed forward is formed inside the rear connector portion 13. A bottom surface of the fitting recessed portion 15 is formed by a part of the rear end surface of the body portion 11. The counterpart rear connector is fitted to the fitting recessed portion 15.

As shown in FIGS. 1, 2, and 5, an annular recessed portion 16 is formed on an outer peripheral surface of the front connector portion 12 (see FIG. 5). An O ring 50 is fitted in the annular recessed portion 16. As shown in FIGS. 1 to 3, a flange portion 17 extending radially outward from an outer peripheral surface of a rear end portion of the body portion 11 is integrally formed on the body portion 11. A through hole 18 that is used for collar attachment and passes through the flange portion 17 in the front-rear direction is formed at a tip end portion of the flange portion 17. A cylindrical collar 60 formed of metal is attached to the through hole 18.

As shown in FIG. 5, the housing 10 is attached to the outer wall 40 of the case by fastening and fixing the flange portion 17 to the outer wall 40 using a bolt (not shown) inserted into the collar 60 in a state in which the front connector portion 12 is inserted into an attachment hole 43 from an outer surface 41 side. The attachment hole 43 is formed on the outer wall 40 of the case and has a cylindrical inner peripheral surface.

When attachment of the housing 10 to the outer wall 40 of the case is completed (see FIG. 5), a minute annular gap between an inner peripheral surface of the attachment hole 43 of the outer wall 40 and an outer peripheral surface of the front connector portion 12 is liquid-tightly and air-tightly sealed by the O ring 50. Accordingly, air or water at an outer surface 41 side of the outer wall 40 of the case and oil at an inner surface 42 side of the outer wall 40 of the case are separated.

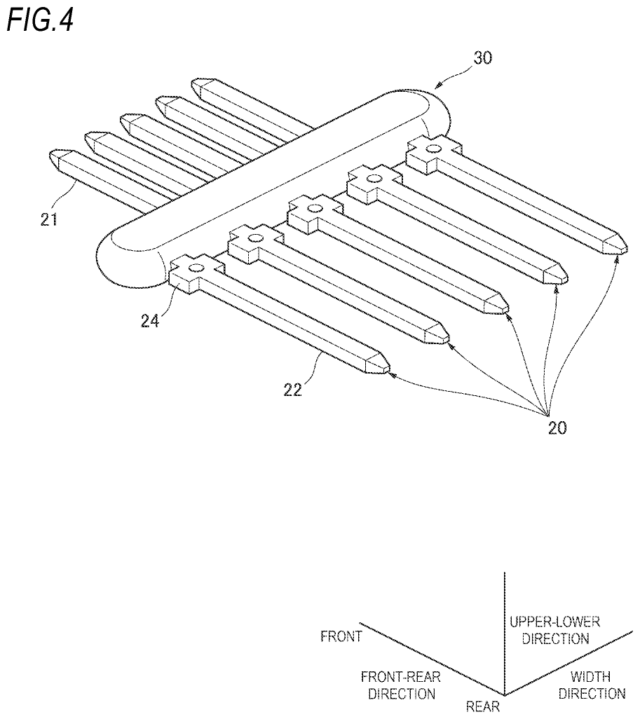

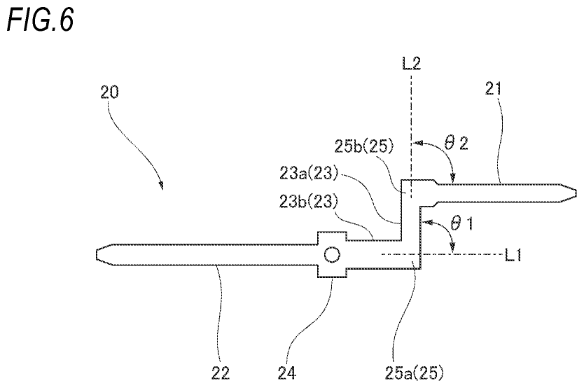

Next, the metal terminals 20 will be described. In this example, the plurality of metal terminals 20 shown in FIGS. 4 to 6 are manufactured by cutting so-called chain terminals respectively at predetermined positions of a strip-shaped carrier (not shown) corresponding to the metal terminals 20. The chain terminals are formed by coupling portions corresponding to the plurality of metal terminals 20 in a state of being aligned in a row by the carrier. Therefore, a carrier mark portion 24 remains at each of the metal terminals 20 (see FIGS. 5 and 6).

As shown in FIGS. 5 and 6, each metal terminal 20 includes a front contact portion 21 located at a front side and extending linearly in the front-rear direction, a rear contact portion 22 located at a rear side and extending linearly in the front-rear direction, and the intermediate portion 23 that couples the front contact portion 21 and the rear contact portion 22. A width of the intermediate portion 23 is larger than a width of the front contact portion 21 and a width of the rear contact portion 22.

In this example, as shown in FIG. 5, a plurality of (five) metal terminals 20 are aligned in a row in the width direction such that the metal terminals 20 are held in the housing 10 (the body portion 11). The front contact portions 21 of the plurality (five) metal terminals 20 protrude forward from the bottom surface of the fitting recessed portion 14 in the fitting recessed portion 14 of the front connector portion 12. Therefore, when the counterpart front connector is fitted to the fitting recessed portion 14, a plurality of front contact portions 21 (male terminals) and a plurality of terminals (female terminals (not shown)) accommodated in the counterpart front connector are electrically connected.

The rear contact portions 22 of the plurality of (five) metal terminals 20 protrude rearward from the bottom surface of the fitting recessed portion 15 in the fitting recessed portion 15 of the rear connector portion 13. Therefore, when the counterpart rear connector is fitted into the fitting recessed portion 15, a plurality of rear contact portions 22 (male terminals) and a plurality of terminals (female terminals (not shown)) accommodated in the counterpart rear connector are electrically connected.

A pitch of the plurality of rear contact portions 22 (an interval between adjacent rear contact portions 22 in the width direction) aligned in a row in the width direction is larger than a pitch of the plurality of front contact portions 21 (an interval between adjacent front contact portions 21 in the width direction) aligned in a row in the width direction. This is to ensure a space for waterproof plugs for water stopping that are separately and respectively provided at a plurality of terminals accommodated in the counterpart rear connector fitted to the fitting recessed portion 15.

In order to ensure such a pitch relationship, the intermediate portion 23 of one metal terminal 20 located at the center in the width direction extends linearly in the front-rear direction. On the other hand, in order to shift the front contact portions 21 and the rear contact portions 22 in the width direction, each of the intermediate portions 23 of four metal terminals 20 located at two sides in the width direction of the metal terminal 20 located at the center of the width direction has a crank shape having two bent portions 25 bent in opposite directions.

FIG. 6 shows a schematic structure of the metal terminal 20 arranged at a lowermost end in FIG. 5 among the plurality of metal terminals 20 shown in FIG. 5. A bent portion 25a of the metal terminal 20 at a lower side of FIG. 6 is interposed between a portion 23a and the other portion 23b of the intermediate portion 23. Here, an angle θ1 is formed between an extension line L1 obtained by virtually extending a portion of one side that sandwiches the bent portion 25a (that is, the other portion 23b of the intermediate portion 23) and a portion of the other side that sandwiches the bent portion 25a (that is, the portion 23a of the intermediate portion 23). The angle θ1 is defined as a bending angle θ1 (0 degree≤θ1≤180 degrees) of the bent portion 25a. Similarly, an angle θ2 is formed in the bent portion 25b at an upper side of FIG. 6 between an extension line L2 obtained by virtually extending a portion of one side that sandwiches the bent portion 25b (that is, the portion 23a of the intermediate portion 23) and a portion of the other side that sandwiches the bent portion 25b (that is, the front contact portion 21). The angle θ2 is defined as a bending angle θ2 (0 degree≤θ2≤180 degrees) of the bent portion 25b. The same definition can be applied to an object (for example, a boundary surface B to be described later) other than the metal terminal 20.

In this example, the portion 23a and the other portion 23b of the intermediate portion 23 and the front contact portion 2 all have a linear shape. However, when the portion at the one side that sandwiches the bent portion 25 (the other portion 23b) or the portion at the other side (the portion 23a) does not have a strictly linear shape (for example, when either portion is slightly bent), the bending angles θ1 and θ2 may be determined by approximating the shape of the portions (23a and 23b) to a linear shape, or the bending angles θ1 and θ2 may be determined using tangents of the portions (23a and 23b). The same definition can he applied to an object (for example, the boundary surface B to he described later) other than the metal terminal 20.

According to the above definitions, both of the bending angles θ1 and θ2 of the bent portions 25a and 25b of the metal terminal 20 shown in FIG. 6 are 90 degrees. Except for the linear metal terminal 20 located at the center in the width direction in FIG. 5, bending angles of the bent portions 25 of the other metal terminals 20 in FIG. 5 are all 90 degrees.

An amount of shift between the front contact portion 21 and the rear contact portion 22 for a pair of metal terminals 20 located at two end portions in the width direction is larger than an amount of shift between the front contact portion 21 and the rear contact portion 22 for a pair of metal terminals 20 located adjacent to the metal terminal 20 located at the center in the width direction.

As shown in FIG. 5, the intermediate portions 23 of the plurality of metal terminals 20 are embedded in the body portion 11 of the housing 10 by insert-molding in a state in which the intermediate portions 23 of the plurality of metal terminals 20 are collectively covered by the buffer member 30. The buffer member 30 is formed of a resin material or a rubber material having higher flexibility than a resin material forming the housing 10.

In order to obtain the housing 10, first, as a primary molding, the buffer member 30 is molded to collectively cover the intermediate portions 23 of the plurality of metal terminals 20 using a mold (not shown) for the primary molding in a state in which the plurality of the metal terminals 20 are positioned relative to one another in a manner of being aligned in the width direction as shown in FIG. 4. Next, as a secondary molding, the intermediate portions 23 of the plurality of metal terminals 20 and the buffer member 30 are embedded into the body portion 11 using a mold (not shown) for the secondary molding. In this manner, the housing 10 is molded.

Accordingly, as shown in FIG. 5, the housing 10 is obtained in which the intermediate portions 23 of the plurality of metal terminals 20 and the buffer member 30 collectively covering the plurality of intermediate portions 23 are embedded and held in the body portion 11. The buffer member 30 covers the plurality of intermediate portions 23 in a manner of covering at least all of the plurality of bent portions 25 (eight portions in this example) of the plurality of intermediate portions 23. Therefore, in the housing 10, all of the plurality of bent portions 25 of the plurality of intermediate portions 23 are not directly in contact with the body portion 11, and the buffer member 30 is present between the plurality of bent portions 25 and the body portion 11.

During the secondary molding, due to a difference in thermal expansion coefficients of a metal material forming the metal terminals 20 and a resin material forming the housing 10, a minute gap is inevitably formed between each of the metal terminals 20 embedded in the body portion 11 and the body portion 11 (around side faces of the metal terminals 20) after the housing 10 is molded. In order to seal such a gap and ensure a water stopping property of the connector 1, in this example, a potting material 70 is poured toward the bottom surface of the fitting recessed portion 15 of the rear connector portion 13 when the housing 10 is maintained in an orientation in which the rear connector portion 13 faces vertically upward and the front connector portion 12 faces vertically downward. Accordingly, the potting material 70 enters the gap between each of the metal terminals 20 and the body portion 11 due to the force of gravity acting on the potting material 70, thereby sealing the gap.

In this example, as shown in FIG. 4, the entire outer surface of the buffer member 30 has a smooth shape formed by a flat surface or a smooth curved surface. The entire buffer member 30 is embedded in the body portion 11 of the housing 10. Therefore, the entire outer surface of the buffer member 30 in the body portion 11 forms the boundary surface B (see FIG. 5) between the buffer member 30 and the body portion 11. In any cross section of the buffer member 30, the boundary surface B has a smooth boundary shape that does not have a portion bent at a bending angle equal to or larger than the bending angle (90 degrees in this example) of the bent portion 25. As described above, the bending angle of the boundary surface B can be determined according to the same definition described above.

As described above, according to the connector 1 according to the embodiment of the present invention, the bent portions 25 of the metal terminals 20 formed of a metal material are covered by the buffer member 30 formed of a material having higher flexibility than a resin material forming the housing 10. When the buffer member 30 is embedded in the housing 10, the metal terminals 20 are held in the housing 10. That is, the bent portions 25 of the metal terminals 20 are not directly in contact with the housing 10, and the buffer member 30 is present between the bent portions 25 of the metal terminals 20 and the housing 10. Therefore, even when the connector 1 is exposed to a large temperature change when the connector 1 is used, the buffer member 30 having excellent flexibility absorbs a difference in deformation degrees of the resin material forming the housing 10 and the metal material forming the metal terminals 20, so that an internal stress occurring around the boundary surface between the metal terminals 20 and the housing 10 is reduced. Accordingly, deformation or cracking of the housing 10 is prevented.

As a result, it is possible to prevent poor separation between air or water at the outer surface 41 side of the outer wall 40 of the case and oil at the inner surface 42 side of the outer wall 40 of the case due to, for example, a crack that occurs in the housing 10 in a manner of crossing an inner space of the O ring 50 in the front-rear direction. Further, it is possible to prevent poor separation between air or water at the outer surface 41 side of the outer wall 40 of the case and oil at the inner surface 42 side of the outer wall 40 of the case due to, for example, a reduction in strength of the housing 10 and a reduction in a contact pressure between the inner peripheral surface of the attachment hole 43 and the O ring 50 when a crack occurs in the housing 10. Therefore, even when the connector 1 according to the present embodiment is exposed to a large temperature change when the connector 1 is used, deformation or cracking of the housing 10 can be prevented and an original function can be maintained. That is, the connector 1 is excellent in resistance to a temperature change.

According to the connector 1 in the present embodiment, the boundary surface B between the housing 10 and the buffer member 30 has a smooth boundary shape that does not have a portion bent at an angle equal to or larger than the bending angle (90 degrees) of the bent portions 25 of the metal terminals 20 in any cross section of the buffer member 30. Therefore, a large internal stress can be prevented from occurring in the housing 10 around the boundary surface between the buffer member 30 and the housing 10. Therefore, the connector 1 according to the present embodiment can further improve the resistance to a temperature change.

According to the connector 1 in the present embodiment, the buffer member 30 is not exposed to the outside of the housing 10 (in particular, a front connector portion 12 side exposed to oil). Therefore, it is not necessary to consider durability with respect to oil of a material forming the buffer member 30. Therefore, the degree of freedom of selecting the material forming the buffer member 30 is increased while focusing on excellent flexibility.

According to the connector 1 in the present embodiment, the plurality of bent portions 25 of the plurality of metal terminals 20 are collectively covered by the buffer member 30. Therefore, as the primary molding, the buffer member 30 is molded in a state in which the plurality of metal terminals 20 are positioned relative to one another, as the secondary molding, the plurality of the metal terminals 20 and the buffer member 30 are collectively insert-molded in the housing 10, such that the connector 1 can be manufactured. Thus, according to the connector 1 in the present embodiment, productivity of the connector including the plurality of metal terminals 20 can be improved.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

In the embodiment described above, the boundary surface B between the housing 10 and the buffer member 30 has a shape (that is, the smooth boundary shape) that does not have a portion bent at a bending angle equal to or larger than the bending angle (90 degrees) of the bent portions 25 of the metal terminals 20 in any cross section of the buffer member 30. On the other hand, for example, depending on a degree of resistance to a temperature change required for the connector 1, the boundary surface B between the housing 10 and the buffer member 30 may have a portion bent at a bending angle equal to or larger than the bending angle (90 degrees) of the bent portions 25 of the metal terminals 20 in a specified cross section of the buffer member 30.

In the embodiment described above, the entire buffer member 30 is embedded in the body portion 11 of the housing 10. On the other hand, for example, depending on an environment in which the connector 1 is used, a part of the buffer member 30 may be exposed to the outside of the housing 10 (specifically, the front connector portion 12 side exposed to oil or the rear connector portion 13 side exposed to air or water).

In the embodiment described above, the intermediate portions 23 of the plurality of metal terminals 20 and the buffer member 30 that collectively covers the plurality of intermediate portions 23 are embedded and held in the body portion 11 of the housing 10. On the other hand, the intermediate portion 23 of a single metal terminal 20 and the buffer member 30 that covers the single intermediate portion 23 may be embedded and held in the body portion 11 of the housing 10.

According to the above exemplary embodiments, a connector (1) comprising:

a housing (10) comprising a resin material;

a buffer member (30) comprising a material having a higher flexibility than the resin material of the housing (10) and being embedded in the housing (10); and

a metal conductor (20) having a bent portion (25) and being held in the housing (10) so as for the bent portion (25) being covered by the buffer member (30).

According to the connector having the above configuration, the buffer member formed of a material having higher flexibility than the resin material forming the housing covers the bent portion of the metal conductor. The conductor is held in the housing in a state in which the buffer member is embedded in the housing. That is, the buffer member is present between the bent portion of the conductor and the housing, and the bent portion of the conductor and the housing are not directly in contact with each other. Therefore, even when the connector is exposed to a large temperature change, a difference in deformation degrees of the resin material forming the housing and the metal material forming the conductor is absorbed (reduced) by the buffer member having excellent flexibility. Accordingly, an internal stress occurring around the boundary surface between the housing and the conductor is reduced, and deformation, cracking, or the like of the housing is prevented. Therefore, the connector having the configuration can maintain an original function even when the connector is exposed to a temperature change, and has excellent resistance to a temperature change. The expression “higher flexibility” can be rephrased to, for example, a small value of an elastic modulus.

The connector (1) may be configured such that the conductor (20) has a rod shape and is bent in a predetermined bending angle (θ1, θ2) at the bent portion (25), and

the buffer member (30) has an outer surface to define a boundary surface (B) between the housing (10) and the buffer member (30) inside the housing (10), and the boundary surface (B) has a smooth boundary shape in any cross section of the buffer member (30) to have no boundary portion bent at an angle equal to or larger than the bending angle (θ1, θ2).

According to the connector having the above configuration, the boundary surface between the buffer member and the housing has a smooth shape (that is, a smooth boundary shape) that does not have an irregular shape exceeding an unevenness degree of the bent portion of the conductor. Specifically, in any cross section of the buffer member, the boundary surface between the buffer member and the housing does not have a portion bent at a bending angle equal to or larger than the bending angle of the bent portion of the conductor. Accordingly, a large internal stress can also he prevented from occurring in the housing around the boundary surface between the buffer member and the housing. Therefore, the connector having the configuration can further improve the resistance to a temperature change. As shown in FIG. 6, the “bending angle” indicates an angle (0 degree or more and 180 degrees or less) formed between an extension line obtained by virtually extending a portion of one side that sandwiches a bent portion and a portion of the other side that sandwiches the bent portion. That is, the smaller the bending angle (that is, closer to zero), the smaller an unevenness degree of the bent portion.

The connector (1) may be configured such that the entire buffer member (30) is embedded in the housing (10).

According to the connector having the above configuration, the buffer member is embedded in the housing and is not exposed to the outside of the housing. Therefore, it is not necessary to consider environmental resistance (for example, durability with respect to oil when the connector is exposed to oil) of the material forming the buffer member. Therefore, the material forming the buffer member can be selected while focusing on that the buffer member has an excellent characteristic (for example, flexibility). That is, the degree of freedom of selecting the material forming the buffer member is increased.

The connector (1) may be configured such that the connector (1) comprising a plurality of the conductors (20), and

the buffer member (30) collectively covers a plurality of the bent portions (25) of the plurality of the conductors (20).

According to the connector having the above configuration, the plurality of bent portions of the plurality of conductors are collectively covered by the buffer member. Therefore, for example, as a primary molding, the buffer member is molded in a state in which the plurality of conductors are positioned relative to one another, and as a secondary molding, the plurality of conductors and the buffer member are collectively insert-molded in the housing, such that the connector can be manufactured. In this case, it is not necessary to consider a positional deviation among the plurality of conductors during the secondary molding, and workability of molding can be improved. As described above, the connector having the configuration includes a plurality of conductors and is excellent in productivity.

According to the present invention, a connector having excellent resistance to a temperature change can be provided.

What is claimed is:

1. A connector comprising:
a housing comprising a resin material;
a buffer member comprising a material having a higher flexibility than the resin material of the housing and being embedded in the housing; and
a metal conductor having a bent portion and being held in the housing so as for the bent portion being covered by the buffer member.

2. The connector according to claim 1, wherein
the conductor has a rod shape and is bent in a predetermined bending angle at the bent portion, and
the buffer member has an outer surface to define a boundary surface between the housing and the buffer member inside the housing, and the boundary surface has a smooth boundary shape in any cross section of the buffer member to have no boundary portion bent at an angle equal to or larger than the bending angle.

3. The connector according to claim 1, wherein
the entire buffer member is embedded in the housing.

4. The connector according to claim 1, wherein
the connector comprising a plurality of the conductors, and
the buffer member collectively covers a plurality of the bent portions of the plurality of the conductors.
